(19) United States
(12) Patent Application Publication
(10) Pub. No.: US 2026/0194695 A1
(43) Pub. Date: Jul. 9, 2026

(54) ANTI-REFLECTION DEVICE WITH SECURE CLIP EXTENSION

(71) Applicant: Defense Distributors LLC, Fort Worth, TX (US)

(72) Inventors: Nicholas Caleb Matichuk, Fort Worth, TX (US); Chris Ernest Matichuk, Sammamish, WA (US)

(21) Appl. No.: 18/603,304

(22) Filed: Mar. 13, 2024

Related U.S. Application Data
(60) Provisional application No. 63/508,560, filed on Jun. 16, 2023.

(51) Int. Cl. G02B 5/00

(52) U.S. Cl. CPC G02B 5/005; G02B 5/003; G02B 2207/123

(57) ABSTRACT

Systems and methods are disclosed for providing and using an anti-reflection device (ARD) to reduce light reflections in an optical device, such as a telescope, binocular, rifle scope, lens, or other optical device. The ARD preferably comprises a lattice conformed to the shape of the optical device with which it will be used, a wall or walls arranged about the perimeter of the lattice to assist with engagement with the lens, housing, and/or other features of the optical device, and at least one clip attached to the wall or walls to assist with secure attachment of the ARD to the optical device. In many embodiments, it will be preferable to employ a lattice comprising at least a portion that is a tessellating pattern, and often convex hexagonal tessellating patterns can be desirable because such shapes offer a larger ratio of viewing area to walls than many other tessellating shapes.

### CROSS-REFERENCE TO RELATED APPLICATIONS

This application claims priority to and the benefit of U.S. Provisional Patent Application Ser. No. 63/508,560, filed Jun. 16, 2023, and entitled “ANTI-REFLECTION DEVICE WITH SECURE CLIP EXTENSION”. The entirety of the aforementioned application is incorporated by reference herein.

### BACKGROUND

In many optical devices, such as telescopes, binoculars, monoculars, camera lenses, rifle scopes, spotting scopes, etc., an excess amount of reflective light is permitted to enter the device. In some circumstances, this excess light may be acceptable and might not cause problems. However, in other circumstances, the excess light may interfere with viewing or capturing images of the desired target of the scope. For example, when using an optical device in a snowy or sandy environment, sunlight might reflect from snow or sand at various angles and travel in a substantially horizontal direction appearing as glare. Such glare might also occur when on or near bodies of water, reflective stone, or buildings (e.g., those having glass windows).

In such situations, it may be desirable to reduce the amount of light entering an optical device from angles that are not substantially parallel to the axis of the line of sight through the optical device. Reducing such light entering from other angles permits the optical device or its user to more easily discern the object(s) being viewed directly or targeted through the optical device.

Suitable devices for reducing such glare and reflective light while also maintaining appropriate positioning during use are lacking from the marketplace. Thus, it would be desirable to provide for suitable devices to reduce glare while also maintaining appropriate positioning of the reflection reducing device with respect to the primary optical device.

For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

For the foregoing reasons, it is desirable to provide an anti-reflection device (ARD) that includes a lattice configured to reduce light reflections in an optical device. The ARD may include one or more walls about the perimeter of the lattice. And the ARD may also include one or more clips attached to these walls to permit attachment of the lattice to an optical device. Optimally, the lattice, clips, and wall will be configured for use with a specific type of optical device so that the clips may clip onto a feature of the optical device, such as an inner or outer housing, an indentation in the housing, a screw hole, a rim on the housing, or another feature that protrudes from or indents into the housing. The clip(s) should be configured to assist with restricting relative motion or movement between the lattice and the optical device, such that the optical device may be transported, stored, or used without easily jarring the ARD loose when bumped or jostled.

For many optical devices, it will be optimal to configure the perimeter of the ARD walls to sit flush against (or near) the housing of the associated optical device, so that the walls help with preventing lateral movement or rotation by coming into contact with portions of the housing if lateral movement or rotation is attempted. In this regard, the lattice may sit against an objective lens (or other protective glass/plastic endpiece) that is opposite the eye piece. This will reduce the light reflections before the light enters into the scope. If such a lens or endpiece has a curvature, it may be desirable to provide a lattice wherein the portion adjacent to the lens or endpiece has a curved surface to conform to the lens or endpiece. It is also possible, but not necessary, to introduce a curved surface on the outward facing end of the lattice. Doing so could maintain a consistent depth of the lattice across the entire lattice, but might not be necessary in many applications. For example, where an ARD is used with a photographic lens, it might be desirable to maintain a consistent lattice depth to ensure more equal exposure of film across the entire lens, whereas in rifle shooting applications, the amount of light in the center portion of the scope (where the target is presumably located) might be more important.

In some optical devices, it may be desirable to attach the ARD using a single clip, while in other devices, it may be more desirable to use two or more clips. In yet other devices, a combination of one or more extensions with tabs and one or more clips may be desirable. For example, two clips on opposite sides of the optical device might be desirable where the clips are affixed to the outside of the optical device housing. As another example, some optical devices may have a partial or full dual housing wherein an inner housing portion is within an outer housing portion that is separated by a gap. In such devices, it may be desirable to form a portion of the ARD wall to fit between the inner and outer housing such that when a force is applied in various directions to the ARD, the portion of the wall between the two housings can prevent relative movement in two or more directions. Where it is feasible, it may be desirable to include a clip on the portion of the wall that fits between the two housings, and it may also be desirable to form that portion of the wall with a curved or arcuate surface with respect to the gap between the two housings, so that when inserted, the wall might be slightly compressed (from curved toward linear) so that the pressure of the two housings helps to secure the ARD against movement relative to the optical device in one or more directions perpendicular to the line of sight through the optical device. Placing the clip at the opposite end of the wall from the lattice (and adjacent to a feature of the optical device on which the clip can be clipped) allows for maintenance of a small amount of pressure against both the front and rear of the optical device to help secure the ARD against movement of the ARD relative to the optical device along the axis of the line of sight through the optical device.

In many embodiments, it may be an object of the invention to use a lattice that includes a partially or fully tessellating pattern of openings through which light can be transmitted, created with thin walls of an acceptable material. And it is often desirable to use a tessellating pattern having a single shape, such as regular convex hexagons (shaped similar to a honeycomb), squares, equilateral triangles, rectangles, diamonds/parallelograms, or parallel lines. It is possible to use other tessellating patterns, or to employ one type of tessellating shape in the central portion of the lattice with one or more other types of tessellating shapes about the perimeter of the lattice. It may also be an object of the invention to form the lattice using a slightly deformable plastic with characteristics that absorb light rather than reflecting light, although it is possible to form the lattice with metal or other materials that can be formed into a lattice having thin walls relative to the amount of open (viewing) area.

In embodiments comprising a tessellating pattern of convex hexagons, it may be desirable that a plurality of the convex hexagons are of substantially similar size. In such arrangements, each hexagon has three opposing pairs of corners that could hypothetically be identified consecutively as corners a, b, c, d, e, and f while circumnavigating about the perimeter of the hexagon. With such designations, the hexagon will have three opposing pairs of corners labeled a-d, b-e, and c-f. In a regular convex hexagon, the distance between corners in pair a-d is equal to the distance between corners in pair b-e and equal to the distance between corners c-f. One might refer to this distance as the span of the hexagon. Where a hexagon is not regular, the distance between a-d might be greater than the distance between b-e or c-f; in such circumstances, the span of the hexagon may be defined as the longest corner-to-corner distance among the three pairs of corners. In the hypothetical of the previous sentence, the distance from a to d would be the span of the hexagon.

In certain embodiments, the ratio of the depth (in a direction substantially parallel to the line of sight) of the walls of the lattice to the span of the hexagons is preferably within certain ranges for enhanced optical properties. A ratio of depth:span of between 2:1 and 3:1 is often preferable. And the ratio of depth:span may have even better optical properties if it is approximately 2.4:1.

The color and reflectivity of the walls of the lattice may be changed to enhance or reduce various optical properties, either through the materials used to construct the lattice or through the use of paint, dye, ink, or other methods of coloring the walls. In many embodiments, the lattice is preferably colored a substantially black or dark grey color with a matte (or “flat”) finish. Both the dark color and the less-reflective matte finish serve to reduce the glare and reflections reaching the optical device. However, in other embodiments, it may be preferable for the lattice to be substantially white or light grey in color and to have a glossy surface. The light color and glossy surface will serve to allow additional light through to the optical device, which might be desirable in low-light settings. Other lattice colors, such as green, blue, brown, yellow, red, etc. may be used where it is desirable to allow the passage of certain wavelengths of light through to the optical device for use in various settings. And the variance between glossy and matte finish may be altered to accommodate various settings.

In various embodiments, it may be desirable to provide two, three, or more clips. Such clips might all be employed simultaneously. Or, it may be desirable to construct an ARD that can work with various types of optical devices, such that certain combinations of one or more clips are employed while in use with one type of optical device while other combinations of one or more clips are employed with other types of optical device(s). In an ARD with two clips that is made for use with a single type of optical device, it may be desirable to arrange the two clips such that they clip to opposite sides of the optical device to enhance stability of the ARD with respect to the optical device. For example, if one imagines that the optical device oriented for viewing substantially parallel to the ground is divided substantially in half by a vertical plane defined by an axis along the line of sight through the optical device and an axis along the direction of gravity, the clips may be arranged on opposite sides of that plane and/or on opposite sides of the axis along the line of sight. Doing so can often enhance the stability of the ARD with respect to the optical device.

In certain embodiments, the ARD may be intended for use with an optical device that has a substantially circular profile, such as many telescopes, camera lenses, or rifle scopes. These embodiments may have a substantially cylindrical wall about the lattice, such that a circular portion of the wall conforms to the circular profile of the optical device. In such embodiments, where the optical device has a rim or flange about the end portion adjacent to the ARD, it may be desirable to arrange the clips of the ARD to clip onto the rim or flange of the optical device.

In many embodiments of the inventions described herein, it is desirable to configure the lattice, wall(s), and clip(s) to restrict relative movement of the lattice, with respect to the optical device, in all directions when the ARD is clipped to the optical device.

Various embodiments of the present invention may incorporate one or more of these and the other features described herein. A better understanding of the nature and advantages of the present invention may be gained by reference to the following detailed description and the accompanying drawings.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a rifle system including an embodiment of the inventive anti-reflection device;

FIG. 2 illustrates a first embodiment of the inventive anti-reflection device in the context of a sight;

FIG. 3 illustrates a first embodiment of the inventive anti-reflection device in the context of a sight;

FIG. 4 illustrates a close-up cutaway view of a clip extension of a first embodiment of the inventive anti-reflection device from the perspective indicated in FIG. 3;

FIG. 5 illustrates a perspective view of a first embodiment of the inventive anti-reflection device;

FIG. 6 illustrates a perspective view of a first embodiment of the inventive anti-reflection device;

FIG. 7 illustrates an end view of a first embodiment of the inventive anti-reflection device;

FIG. 8 illustrates a bottom view of a first embodiment of the inventive anti-reflection device;

FIG. 9 illustrates an end view of a first embodiment of the inventive anti-reflection device;

FIG. 10 a side view of a first embodiment of the inventive anti-reflection device;

FIG. 11 illustrates a second embodiment of the inventive anti-reflection device in the context of a sight;

FIG. 12 illustrates a perspective view of a second embodiment of the inventive anti-reflection device;

FIG. 13 illustrates a side cutaway view of a second embodiment of the inventive anti-reflection device in the context of a sight from the perspective indicated in FIG. 11;

FIG. 14 illustrates an end view of a second embodiment of the inventive anti-reflection device;

FIG. 15 illustrates a bottom view of a second embodiment of the inventive anti-reflection device;

FIG. 16 illustrates an end view of a second embodiment of the inventive anti-reflection device;

FIG. 17 illustrates a side view of a second embodiment of the inventive anti-reflection device;

FIG. 18 illustrates a perspective view of a third embodiment of the inventive anti-reflection device;

FIG. 19 illustrates a perspective view of a third embodiment of the inventive anti-reflection device;

FIG. 20 illustrates atop view of a third embodiment of the inventive anti-reflection device;

FIG. 21 illustrates an end view of a third embodiment of the inventive anti-reflection device;

FIG. 22 illustrates a bottom view of a third embodiment of the inventive anti-reflection device;

FIG. 23 illustrates a side view of a third embodiment of the inventive anti-reflection device;

FIG. 24 illustrates an end view of a third embodiment of the inventive anti-reflection device;

FIG. 25 illustrates a fourth embodiment of the inventive anti-reflection device in the context of a sight;

FIG. 26 illustrates a perspective view of a fourth embodiment of the inventive anti-reflection device;

FIG. 27 illustrates a perspective view of a fourth embodiment of the inventive anti-reflection device;

FIG. 28 illustrates an end view of a fourth embodiment of the inventive anti-reflection device;

FIG. 29 illustrates a top view of a fourth embodiment of the inventive anti-reflection device;

FIG. 30 illustrates an end view of a fourth embodiment of the inventive anti-reflection device;

FIG. 31 illustrates a side view of a fourth embodiment of the inventive anti-reflection device;

FIG. 32 illustrates a fifth embodiment of the inventive anti-reflection device in the context of a sight;

FIG. 33 illustrates a close-up cutaway view of a clip extension of a fifth embodiment of the inventive anti-reflection device from the perspective indicated in FIG. 32;

FIG. 34 illustrates a perspective view of a fifth embodiment of the inventive anti-reflection device;

FIG. 35 illustrates a perspective view of a fifth embodiment of the inventive anti-reflection device;

FIG. 36′illustrates an end view of a fifth embodiment of the inventive anti-reflection device;

FIG. 37 illustrates a tope view of a fifth embodiment of the inventive anti-reflection device;

FIG. 38 illustrates an end view of a fifth embodiment of the inventive anti-reflection device;

FIG. 39 illustrates a bottom view of a fifth embodiment of the inventive anti-reflection device; and

FIG. 40 illustrates a side view of a fifth embodiment of the inventive anti-reflection device.

### DETAILED DESCRIPTION OF ILLUSTRATIVE EMBODIMENTS

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details.

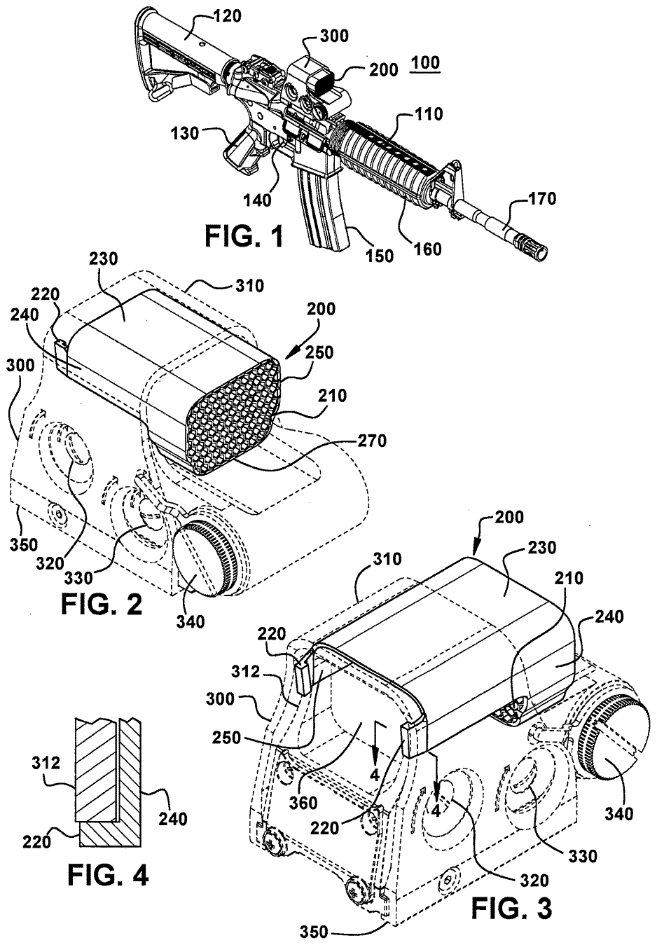

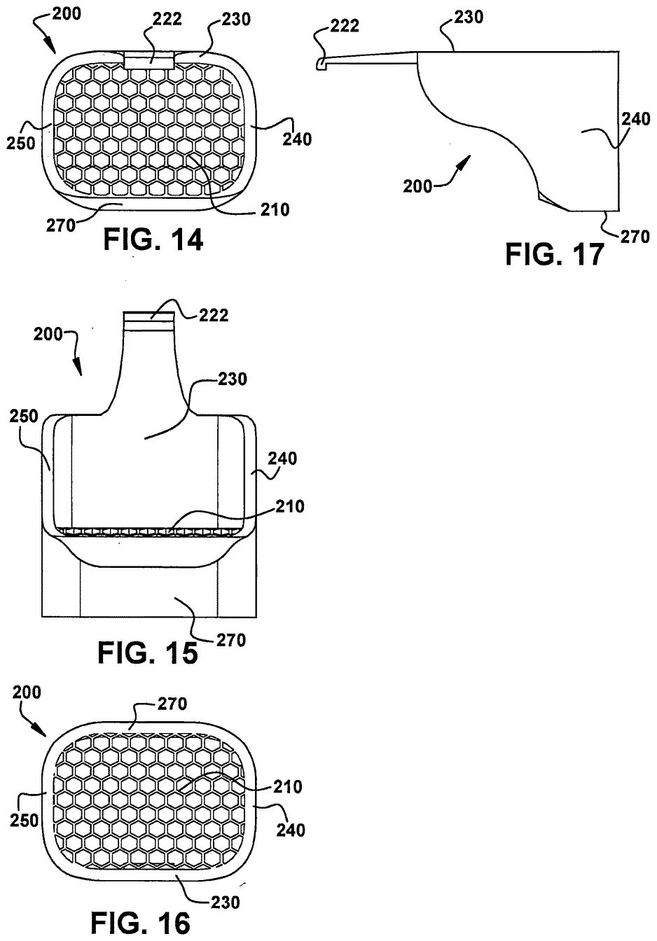

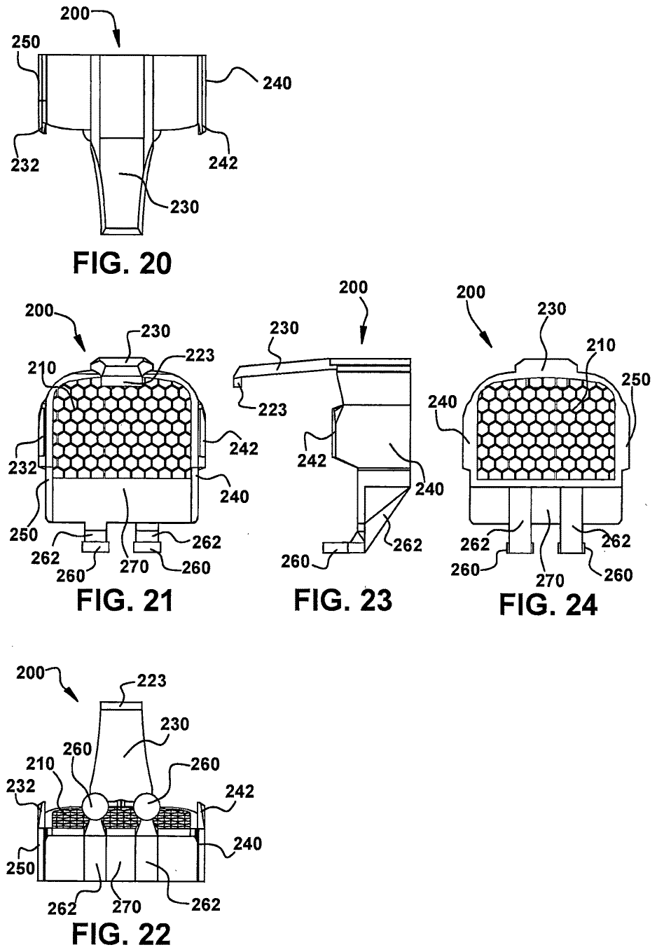

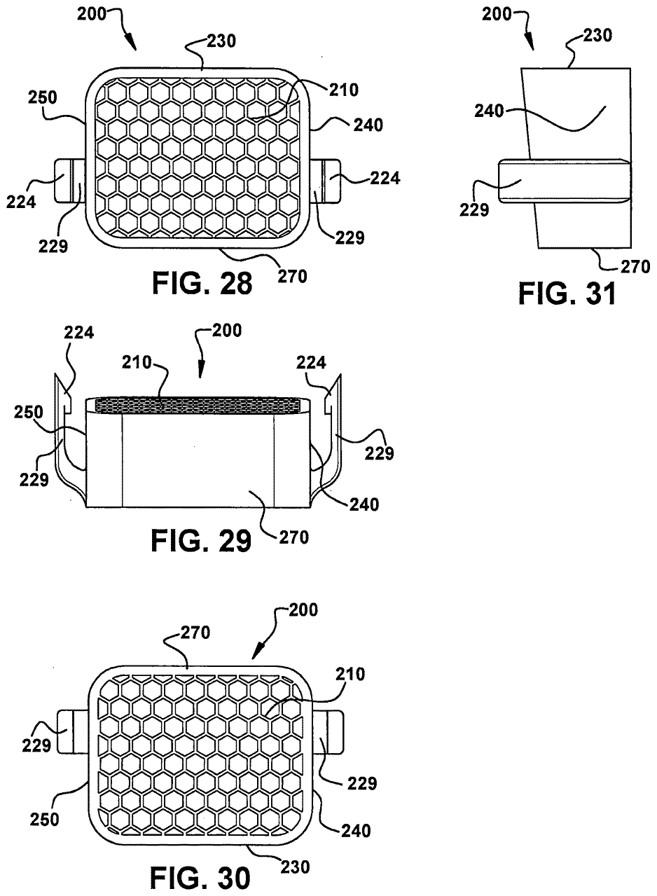

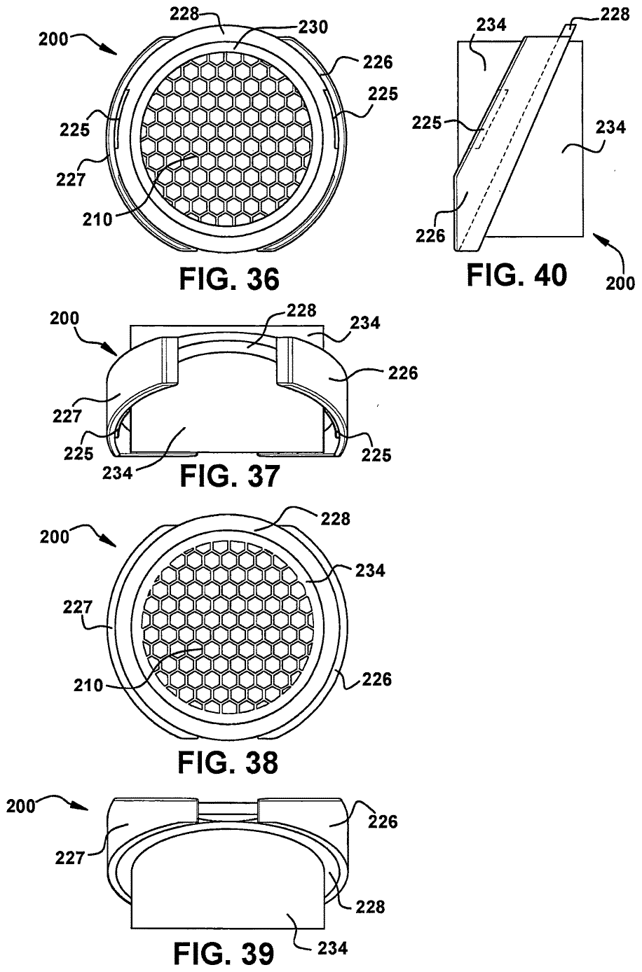

FIGS. 1 through 40 illustrate five different preferred embodiments of the inventive anti-reflection device (“ARD”). Each illustrated embodiment incorporates a portion of the inventive systems and methods set forth herein. Each illustrated embodiment incorporates certain features that may be specific to a particular style of scope.

Referring now to FIG. 1, this illustration provides a perspective view of a rifle system 100 to present an example of an environment in which the inventive devices and methods may be used. The inventive ARD devices and methods of the present application may be used in a variety of settings wherein optics are used and reduction of reflection or glare from excess light is desirable. Such settings may include use with telescopes, binoculars, monoculars, cameras, and other optical devices including various types of sights 300 or scopes for rifles 110. The preferred embodiments presented herein are presented in the context of use with a rifle sight 300 or scope, but it is to be expected that inventive ARD devices of the type disclosed herein may be used with other types of scopes or optical devices and are not limited to use with rifles 110.

As illustrated in FIG. 1, a rifle system 100 is depicted. The rifle system may include a rifle 110. As depicted, the rifle includes a stock 120, a grip 130, a trigger 140, a magazine 150, a hand guard 160, and a barrel 170. For purposes of completeness, a rifle has many other components that are not specifically labeled in FIG. 1. But the illustration of such components is not necessary with respect to disclosure and discussion of the inventive ARD devices and methods set forth herein. As depicted in the rifle system 100, a sight 300 may be mounted to the top of a rifle 110. Various types of sights may be used. The sights illustrated herein are intended to depict preferable holographic sites and are representative of many holographic sights that are available for purchase in the market. With respect to FIGS. 1 through 3, the depicted sight is similar to a sight that is sold under the trade name Eotech HWS EXPS3 at the time of preparation of this disclosure. An inventive ARD 200 is depicted attached to the sight 300.

Turning now to FIGS. 2 through 100, a first preferred embodiment of the inventive ARD apparatuses and methods is depicted herein. FIGS. 2 and 3 depict a sight 300 using dashed lines to provide environmental context for the disclosure of the inventive ARD 200. The sight may include components such as an outer frame 310, an inner frame 312, a first adjustment knob 320, a second adjustment knob 330, a battery compartment 340, one or more mounts 350, and one or more windows 360. It is understood that these components are not all necessary for the use of the inventive ARD. As depicted, a user intending to aim at a target using the sight 300 will look through window 360 in the direction of the target and through lattice 210. When holographic sights are operable and powered on, a user looking through the window 360 will see a holographic reticle (or other indication for targeting). Such holographic reticles are preferably located between the user's eye and the lattice 210 to avoid obstruction of the reticle by a portion of lattice 210. However, it is possible that the lattice may be located between the user's eye and the reticle in some embodiments. In such embodiments, it may be necessary to construct or align the lattice in a manner that does not obstruct the reticle. For example, it may be possible to change the shape of the latticework, to enlarge certain openings in the lattice, or to ensure that the lattice will be aligned in a manner that it will not obstruct the reticle. The same may be true when other types of sights or scopes are used with or without holographic reticles. It is preferable that the sight 300 includes a mount 350 for mounting to the top of a rifle system 110.

As depicted in FIGS. 1 through 40, various embodiments of the inventive ARD 200 may comprise multiple components. A lattice 210 is provided and preferably situated at a location that is furthest from the eye of the viewing user with respect to the other portions of the body and components of the ARD 200 as depicted herein. The lattice 210 may be a tessellating hexagonal lattice 210 as depicted in the Figs. Various structures of lattice 210 may be used and are discussed further below. Referring to FIGS. 1 through 31, the lattice 210 is preferably surrounded on all sides by top wall 230, right side wall 240, left side wall 250, and bottom wall 270. The top wall 230 is connected to right side wall 240 and left side wall 250. The bottom wall 270 is preferably connected to right side wall 240 and left side wall 230 opposite the location of top wall 230. As depicted herein, the composition of the connections between top wall 230, right side wall 240, left side wall 250, and bottom wall 270 are solid and continuous. However the walls 230, 240, 250, 270 may be constructed in a manner that other than a continuous sheet of material for purposes of reducing weight, increasing flexibility, saving materials, or for other purposes. At least one of the walls 230, 240, 250, 270 preferably extends from the lattice 210 in the direction of the eye of a viewing user. As depicted in the first preferred embodiment, top wall 230, right side wall 240, and left side wall 250, all extend from the lattice 210 towards the users eye, while bottom wall 270 is formed to surround the remainder of lattice 210, but does not extend toward the user's eye due to the structure of sight 300. Rather, one or both of the bottom wall 270 and lattice 210 may be designed to be placed snugly against components of sight 300 when the ARD 200 is fully attached to sight 300. Clips 220 extend inward towards the window 360 from the ends of right side wall 240 and left side wall 250 or from projections that themselves extend towards the stock 120 of the rifle 110 towards the place where the user's eye would be expected. Clips 220 are shaped in a manner that allows them to clip to an edge of the inner frame 312 of sight 300 opposite the lattice, to provide resistance against translations along the axis corresponding to the line of sight or the perpendicular axis extending to the left and right of the line of sight.

While not all sights comprise such components (as will be discussed further below, the sight depicted in FIGS. 2 and 3 includes an outer frame 310 and an inner frame 312. The top wall 230, right side wall 240, and left side wall 250 may be inserted between the inner frame 312 and outer frame 310 to reduce translations along and rotations about various axes.

One desirable result of use of the inventive ARD apparatuses and methods is a maintenance of the ARD 200 in static equilibrium with respect to the scope or sight 300 to which the ARD 20Q is attached. This equilibrium can be accomplished by maintaining equal and opposite forces as between the ARD 200 and the scope or sight 300 along and about a set of three mutually perpendicular axes. In particular, it is desirable to maintain the ARD 200 in a state in which the ARD 200 experiences zero or minimal translations or rotations with respect to the scope or sight 300 on which it is mounted. With respect to hypothetical forces in a system defined by three mutually perpendicular axes, a first axis can be defined in the direction of travel of a bullet fired through the rifle barrel or of the user's vision through the sight 300 when the sight 300 is oriented parallel to the ground or a floor. A second perpendicular axis may be defined in the direction of gravity and opposite the direction of gravity. And a third axis may be defined that is perpendicular to the plane defined by the first and second axes. The third axis would generally extend in a direction corresponding to a left and right direction with respect to the direction of vision through a scope or sight 300.

It is preferable that the inventive ARD devices and methods resist translation by including components or structures that resist translation either forward or backwards along the line of sight, along the axis that extends to the right or left of the line of sight, and in or opposite the direction of gravity. Such resistance can be accomplished through construction of some or all of the lattice 210, the side walls 240, 250, the top wall 230, the bottom wall 270, and one or more clips 220 as described herein. Similarly, it is desirable to reduce or eliminate rotations about any of the defined axes, which can be accomplished through the form and position of the components and structures as set forth herein.

In an example of a force that may otherwise impose a translation or rotation on an ARD that does not incorporate the inventive concepts, a scope or sight 300 may be bumped or jarred while viewing or while transporting the scope or sight 300. This may cause the ARD to be loosened, to be detached, or to become oriented incorrectly with respect to the scope or sight. For example, in the case of a rifle system, it is possible that firing a round may cause a recoil that might otherwise that might jar an unsecured ARD loose from the sight or scope 300 mounted on the rifle 110 or which may cause the ARD to translate or rotate in an undesirable manner if the inventive concepts are not applied.

FIG. 4 depicts a close-up cutaway view of an inventive clip 220 of an ARD 200 that is engaged with an end wall of the inner frame of a sight 300. As can be seen, an extension of the right side wall 240 is attached to a clip 220 that has been clipped onto the end of inner frame 312 by inserting components of the ARD 200 including the clips 220, right side wall 240, left side wall 250, and top wall 230 between the outer frame 310 and the inner frame 312 of the sight 300. It is preferable that one or more of these walls 230, 240, 250 have some amount of flexibility such that, while traversing between the inner frame 312 and outer frame 310, the clips may be slightly flexed or rotated away from inner frame 312. Yet when the clips 220 pass the end wall of the inner frame 312, the flexibility may cause the clips 220 to gently flex, rotate, or snap into place to restrain the ARD 200 through opposing forces of the lattice 210 and the clips 220 on opposite ends of the inner frame 312 or other components of the sight 300 that are opposite one another along the axis that corresponds to a user's line of sight through sight 300. Alternatively, the flexibility may cause the clips 220 to be slightly flexed or rotated away from outer frame 310, such that when the clips 220 pass the end wall of outer frame 310, the flexibility may cause the clips 220 to gently flex, rotate, or snap into place to restrain the ARD 200 through opposing forces of the lattice 210 and the clips 220 on opposite ends of the outer frame 310. It is also possible in such an instance, and sometimes preferable to, construct one or more of the top wall 230, right side wall 240, or the left side wall 250, to have a small curvature or angular offset from that axis, so as to increase static forces between the outer frame 310, the inner frame 312, and the one or more walls 230, 240, 250 that were formed with such curvature or deflection, thereby enhancing the static equilibrium of the ARD 200 and reducing or eliminating translation or rotation.

If a user desires to detach the ARD 200 depicted in. FIGS. 2 through 4 from the sight 300, the user may apply a lateral force to the clips 220 (e.g., by using fingers or tools) in a direction opposite to the frame (e.g., outer frame 310, inner frame 312, etc.) to which the clips 220 are clipped. When the clips 220 have cleared the edge of the frame, it is possible to apply a force to the ARD 200 substantially along the axis parallel to line of sight such that the clips and the slightly deformed right wall 240 and left wall 250 may be moved forward in the direction of the line of sight between inner frame 312 and outer frame 310 until the ARD 220 clears at least the outer frame 310 and may be removed from the sight 300.

As noted above, in many embodiments of the inventive ARD, it may be desirable to construct a lattice with a depth:span ratio between 2:1 and 3:1, and more preferably approximately 2.4:1. In certain embodiments related to rifle scopes, this may preferably result in a lattice depth of 12 millimeters and a span of 5 millimeters (without respect to wall thickness). However, in other embodiments, the size and ratios of depth:span may vary. For further reduction of reflection, the ratio may be increased beyond 3:1. Reduction of the ratio below 2:1 may result in an excessive amount of reflection entering the optical device. For use with certain types of optical devices (e.g., pistol scopes), it may be necessary to have a lattice depth smaller than 12 mm; this can be accommodated by maintaining the ratio by using a smaller span or by altering the depth:span ratio. Notably, it is preferable to construct the lattice walls as thin as possible within a manufacturing process, while also retaining strength and opacity. Where the walls are constructed of metal rather than plastic, it may be possible to employ a thinner wall while retaining sufficient levels of both strength and opacity. Certain manufacturing processes may require lattices to have walls that are thicker than would be required for sufficient strength and opacity; thus, the thickness of lattice walls may be constrained by manufacturing processes rather than by optimization.

In certain embodiments of the inventive ARD devices and methods, it may be desirable to employ a modular design whereby the lattice can be removed from the remainder of the ARD and swapped with a different lattice. This can allow for the use of different lattices with a single optical device without having to remove the clipped-on body of the ARD. For example, one might switch between different color lattices based on light conditions. Or one might switch between different tessellating patterns based on the intended use.

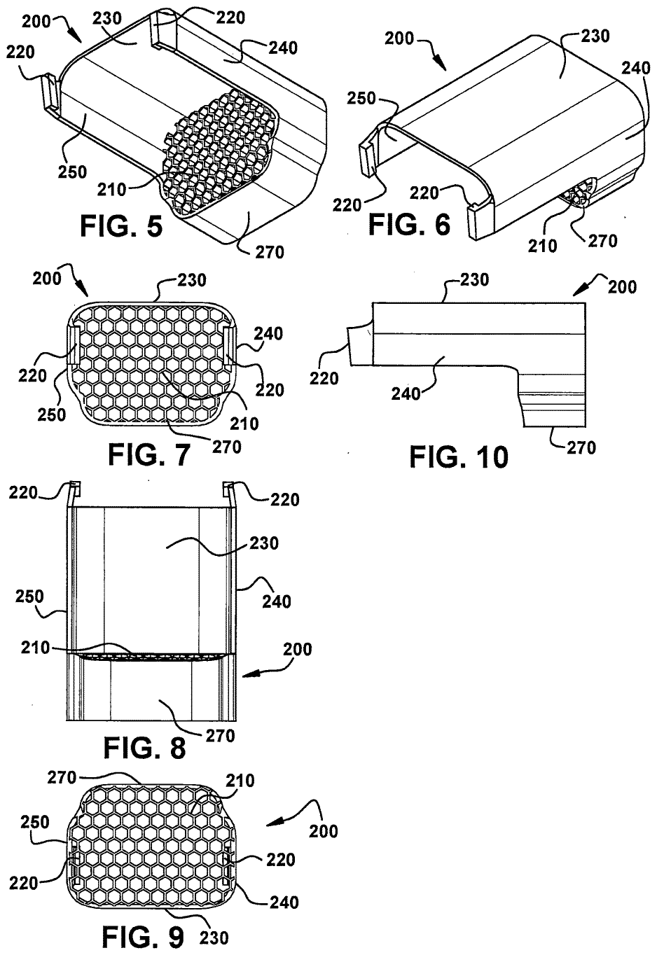

FIGS. 5 through 10 depict various views of the same embodiment of the ARD 200 that is depicted in FIGS. 2-4, wherein the numbering of depicted elements corresponds to the same numbering scheme used above. FIG. 5 provides a perspective view. FIG. 6 provides another a perspective view. FIG. 7 provides an end view with clips 220 in the foreground and lattice 210 in the background. FIG. 8 provides a bottom view. FIG. 9 provides an end view with the lattice 210 in the foreground and tabs 220 in the background. FIG. 10 provides a side view.

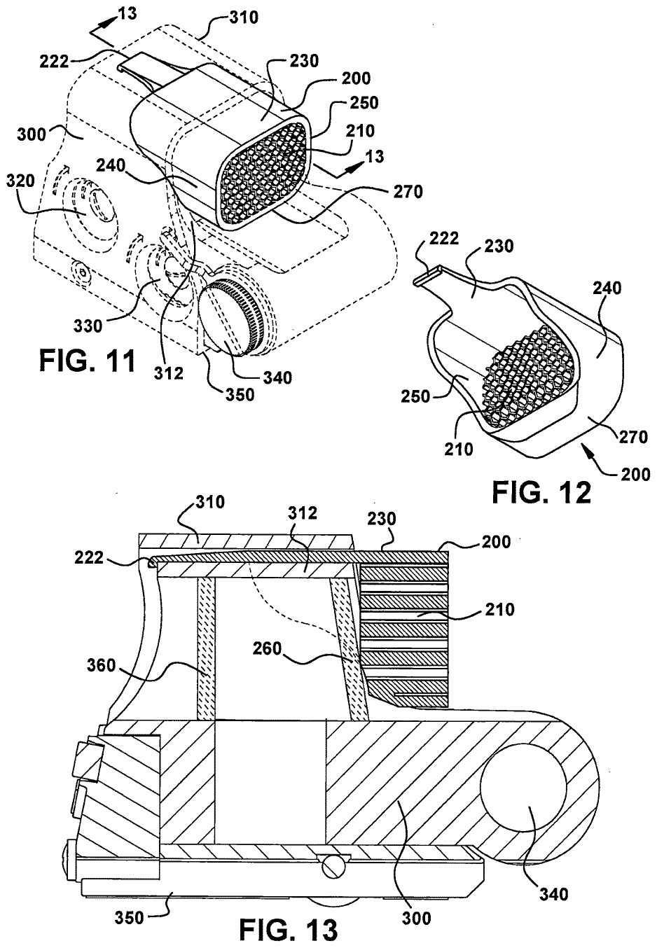

FIGS. 11 through 17 depict another embodiment of the inventive ARD 200. In these FIGS., the depicted sight 300 is similar to a sight that is sold under the trade name Eotech HWS 512 at the time of preparation of this disclosure. As depicted, this sight may include outer frame 310, inner frame 312, adjustment knobs 320, 330, battery compartment 340, mount 350, and windows 360. The ARD 200 depicted in FIGS. 11 through 17 has a single clip 222 rather than having multiple clips. Clip 222 can be inserted between outer frame 310 and inner frame 312, and can be configured to clip onto either frame 310 or 312. As depicted in FIGS. 11 through 17, clip 222 is configured to clip onto inner frame 312 and operates in a manner very similar to that depicted with respect to clips 220. In this embodiment, lattice 210 may be configure to make contact with window 360 while clip 222 is clipped to one of frames 310 or 312 such that the combination of elements prevents translation along the line of sight relative to the sight 300. It can also be seen that side walls 240, 250 and top wall 230 are all configured to be positioned between outer frame 310 and inner frame 312 to prevent translation along axes that are perpendicular to the line of sight. Similarly, bottom wall 270 may be formed to be in contact with sight 300 to further prevent translation along certain axes perpendicular to the line of sight through sight 300.

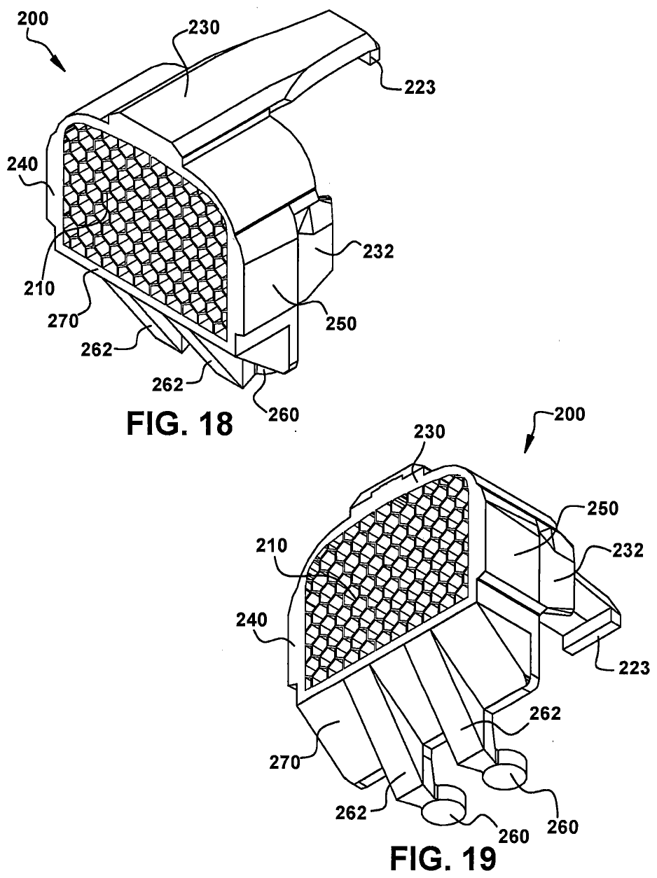

FIGS. 18 through 24 depict another embodiment of the inventive ARD 200. In these FIGS., no sight is depicted. The ARD 200 has a single clip 223 rather than having multiple clips. Clip 223 and wall 230 may be inserted between an outer frame and inner frame of a sight to clip onto either; alternatively, clip 223 may clip onto the outer frame (or a single frame) of a sight that does not have two frames. Opposite wall 230 are tabs 260 that are attached to wall 270 by supports 262. Tabs 260 may be formed with various shapes to conform to various features of a sight. As depicted, tabs 260 are cylindrical tabs formed to fit into depressions in a sight's frame where the depressions correspond to holes formed for inserting screws or other connectors, such as those that may be found on the bottom of a sight that is sold under the trade name Holosun HS510C at the time of preparation of this disclosure. Similar to clip 223 and other features of the ARD 200, tabs 260 may prevent translation and rotation with respect to various axes by virtue of fitting into a depression that is circular in shape. While two tabs 260 are depicted, the inventive ARD 200 may be configured with more or fewer tabs 260. Also depicted are projections 232 and 242; projection 232 projects from wall 250 while projection 242 projects from wall 240. Projections 232 and 242 may be configured to make contact with the outer portion of a sight's outer frame, to be inserted between a sight's inner frame and outer frame, or to make contact with the inner portion of a sight's frame (either inner or outer). Projections 232 and 242 may have a degree of flexibility such that pressure between the projections 232 and 242 and a sight's frame are maintained or even increased when the ARD 200 is clipped to the sight. Projections 232 and 242 are alternative options for maintaining static equibrium of the ARD 200 to prevent various translations and rotations with respect to a sight while engaged. While ARD 200 is depicted with two projections, it is possible to configure an ARD with more or fewer projections. In certain embodiments tabs 260 may be attached directly to a wall, such as wall 270; however, various sights may be configured such that it is desirable to use supports 262 to position the tabs 260 in alternative positions with respect to the location of a wall such as wall 270.

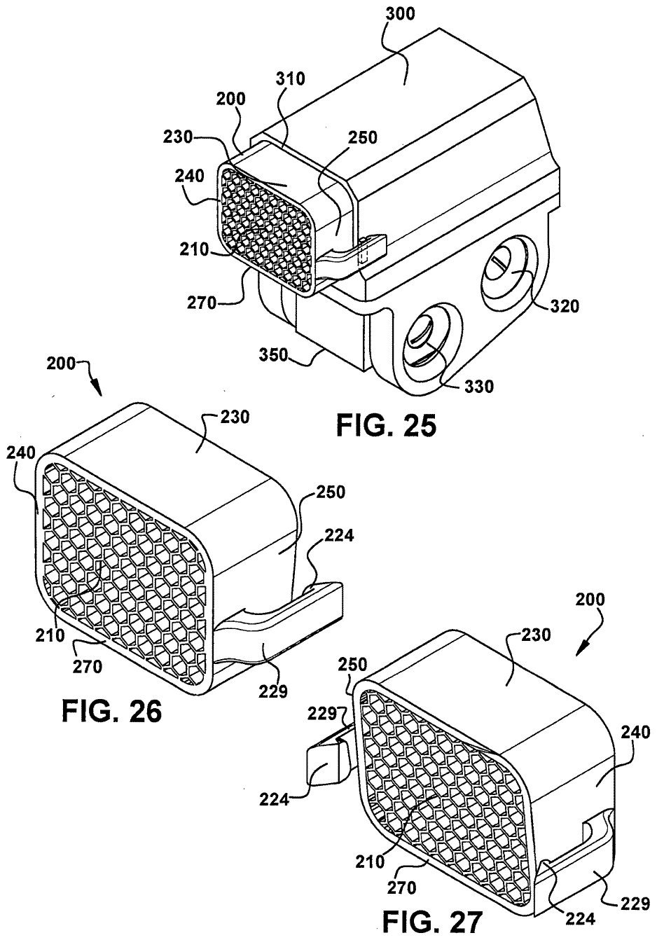

FIGS. 25 through 31 depict another embodiment of the inventive ARD 200. In FIG. 25, the depicted sight 300 is similar to a sight that is sold under the trade name Vortex Optics AMG UH-1 Gen II Holographic Sight at the time of preparation of this disclosure. As depicted, this sight 300 may include outer frame 310, adjustment knobs 320, 330, and mount 350. As shown in FIG. 25, the ARD 200 may be configured such that walls 230, 240, 250, and 270 are formed to fit snugly within the contours of outer frame 210 of the sight 300, so as to prevent translations along axes perpendicular to the line of sight through sight 300 as well as preventing various rotations. While no features within sight 300 are depicted in FIG. 25, it is understood that ARD 200 may be configured to make contact with an inner feature of sight 300 (such as a window) to prevent translations along the axis of the line of sight towards a viewer's eye. FIGS. 29 and 31 demonstrate an example of the lattice 210 being thicker at the top than at the bottom, so that the portion of the lattice (or corresponding walls) closest to the sight 300 may make contact with an inner feature such as a window within the sight 300. Clips 224 mounted on projections 229 prevent translations along the axis of line of sight away from a viewer's eye when clipped to features on the sight 300, while also preventing various rotations and maintaining the ARD 200 in static equilibrium with respect to the sight 300. While it is not depicted in these figures, in an alternative embodiment, it is also possible to configure projections 229 to make contact with the end of frame 310 when clips 224 are clipped to features on sight 300 such that the combination of projections 229 and clips 224 prevent translations along the axis corresponding to the line of sight without the need for any portions of the ARD 200 to make contact with features inside the frame 310. In yet another alternative embodiment, one or both projections 229 may be extended to reach the far end of frame 310 such that one or more clips 224 may clip to the opposite end of frame 310 rather than clipping to a feature on the frame 310. Clips 224 may be configured and formed similar to clips 220, 222, and 223.

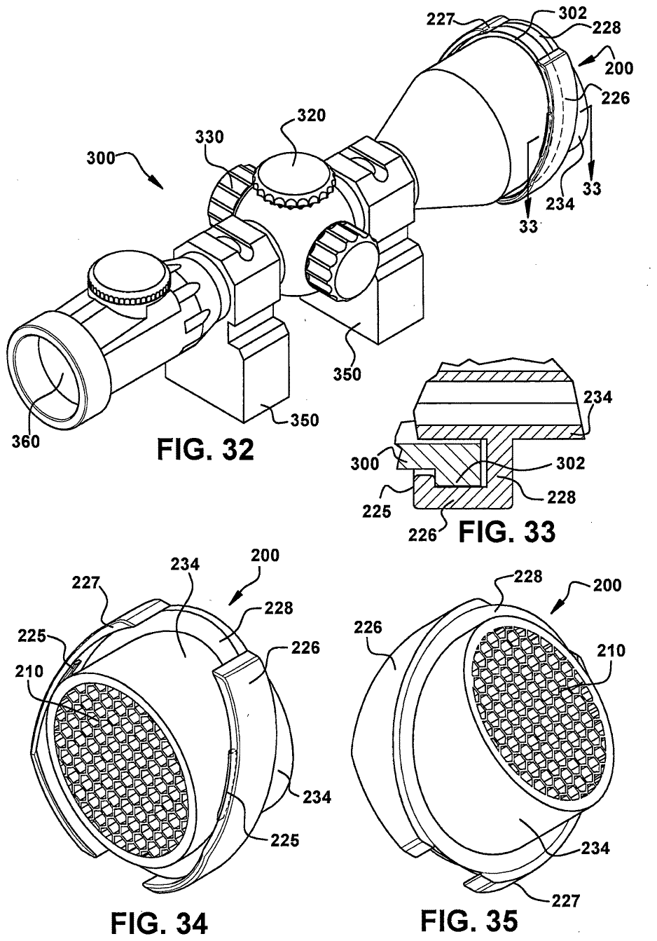

FIGS. 32 through 40 depict another embodiment of the inventive ARD 200. In FIG. 32, the depicted sight 300 is similar to a sight that is sold under the trade name Trijicon 4X32 BAC ACOG Rifle Scope at the time of preparation of this disclosure. As depicted, this sight 300 may include a rim (or flange) 302, adjustment knobs 320, 330, mount 350, and window 360. Because this embodiment is configured for use with a sight 300 having a substantially circular profile, lattice 210 may be fully or partially surrounded by a cylindrical wall 234 that can be configured to fit inside an outer frame of sight 300 and fit snugly against such frame to prevent various rotations and translations of ARD 200. A rim 228 may be formed to make contact with the front end of sight 300. In many sights of this general configuration, the front end of the sight and corresponding rim 302 do not sit on a plane that is perpendicular to the line of sight through sight 300, but rather are at an angle. Thus, as depicted in FIGS. 32 through 40, the rim 228 is formed as a diagonally oriented ellipsoid rim, rather than a strictly circular rim so as to permit the rim 228 to conform to rim (or flange) 302.

FIG. 32 shows projection lines labeled 33 that correspond with the cutaway portion shown in FIG. 33. As depicted in FIG. 33, rim 302 is inserted between cylindrical wall 234 and right arcuate projection 226 until clip 225 can clip onto rim 302, thereby operating in concert with rim 228 to prevent translations along the axis of the line of sight through sight 300 as well as preventing various rotations. The same may be done on the opposite side of sight 300 with respect to left arcuate projection 227 and its clip 225.

Referring to FIGS. 32 through 40, the combination cylindrical wall 234, right arcuate projection 226, left arcuate projection 227, and clips 225 maintain the ARD 200 in static equilibrium with respect to sight 300. In certain embodiments, it may be desirable to configure ARD 200 with only a single projection and clip, whereas in other embodiments it may be desirable to employ more than two projections and clips. The arcuate length of projections 227, 228 and clips 225 may be increased or decreased while staying within the scope of the invention. It is preferable to form projections 227, 228 in a manner that allows a small amount of flexibility such that clips 225 can flex away from sight 300 as they are clipped around rim 302, before flexing back into position after clearing rim 302.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments include a system as well as the various methods of the claimed subject matter.

What is claimed is:

1. An anti-reflection device comprising:
a lattice configured to reduce light reflections;
at least one wall arranged about a perimeter of the lattice;
one or more clips attached to at least one of the at least one wall;
wherein the one or more clips and at least one of the at least one wall are configured for attachment of the lattice to an optical device; and
wherein the one or more clips are arranged to clip onto a feature of the optical device to thereby restrict relative movement of the lattice, with respect to the optical device, in a direction of sight through the lattice for a user employing the device.

2. The device of claim 1,
wherein at least one of the at least one wall is configured to substantially conform to a housing of the optical device.

3. The device of claim 2,
wherein when the one or more clips are clipped onto the feature of the optical device, the at least one of the at least one wall is arranged to restrict relative movement of the lattice, with respect to the optical device, in at least one direction that is substantially perpendicular to the direction of sight through the lattice for a user employing the device.

4. The device of claim 3,
wherein the at least one of the at least one wall is configured to fit between two portions of the housing of the optical device.

5. The device of claim 1,
wherein the lattice comprises a tessellating pattern.

6. The device of claim 5,
wherein the lattice comprises a pattern of convex hexagons.

7. The device of claim 6,
wherein a plurality of the hexagons of the lattice have a substantially similar size, each hexagon of the plurality has three opposing pairs of corners, and each opposing pair of corners has a distance between the corners of the pair;
wherein a hexagon's span is defined as the longest of the three distances between the corners of the pair;
wherein the lattice has a substantially uniform depth along an axis that is substantially parallel to the direction of sight through the lattice for a user employing the device; and
further comprising a ratio of depth:span between 2:1 and 3:1.

8. The device of claim 7,
wherein the ratio of depth:span is approximately 2.4:1.

9. The device of claim 1,
wherein the lattice is colored substantially black or substantially white.

10. The device of claim 1, further comprising:
a second clip attached to a second wall of the at least one wall;
the second clip arranged opposite the one or more clips with respect to a vertical plane defined by an axis that is substantially parallel to a direction of sight through the lattice for a user employing the device and an axis that is substantially parallel to a direction of gravity.

11. The device of claim 1,
wherein the at least one wall is substantially cylindrical, and the one or more clips are arranged to clip onto a rim of the optical device.

12. A device for reduction of light reflection in an optical device, comprising:
a lattice having a pattern and a depth both configured to reduce light reflection;
means for conforming the lattice to a housing or a lens of an optical scope to reduce light reflection;
means for clipping the lattice to the optical scope to restrict relative movement of the lattice with respect to the optical device; and
wherein the lattice comprises a tessellating pattern.

13. The device of claim 12,
wherein the lattice comprises a pattern of convex hexagons.

14. The device of claim 13,
wherein a plurality of the hexagons of the lattice have a substantially similar size, each hexagon of the plurality has three opposing pairs of corners, and each opposing pair of corners has a distance between the corners of the pair;
wherein a hexagon's span is defined as the longest of the three distances between the corners of the pair;
wherein the lattice has a substantially uniform depth along an axis that is substantially parallel to the direction of sight through the lattice for a user employing the device; and
further comprising a ratio of depth:span between 2:1 and 3:1.

15. The device of claim 14,
wherein the ratio of depth:span is approximately 2.4:1.

16. A method of reducing light reflection in an optical device, comprising:
positioning an anti-reflection device in contact with the optical device,
wherein the anti-reflection device comprises
a lattice configured to reduce light reflections,
at least one wall arranged about a perimeter of the lattice, and
at least one clip attached to the at least one wall; and
clipping the at least one clip to a feature of the optical device;
thereby restricting relative movement of the lattice, with respect to the optical device, along at least one axis.

17. The method of claim 16, wherein the anti-reflection device further comprises:
a second clip attached to one wall of the at least one wall; and
the method further comprises:
clipping the second clip to a second feature of the optical device.

18. The method of claim 16, wherein
the lattice comprises a tessellating pattern.

19. The method of claim 18, wherein
the lattice comprises a pattern of convex hexagons.

20. The method of claim 16, wherein
relative movement of the lattice, with respect to the optical device, is restricted in all directions.
